(19) United States
(12) Patent Application Publication
(10) Pub. No.: US 2002/0118594 A1
(43) Pub. Date: Aug. 29, 2002

(54) Apparatus and method for mixing small volumes of liquid

(76) Inventors: John C. Vellinger, Floyds Knobs, IN (US); John T. Weber, Poolesville, MD (US); Brock Taylor, Tacoma, WA (US); Nathan Thomas, Louisville, KY (US)

Correspondence Address: Robert H. Eichenberger, Frost Brown Todd LLC, Suite 400, 120 West Spring Street, New Albany, IN, 47150, US

(21) Appl. No.: 10/084,136

(22) Filed: Feb. 27, 2002

Related U.S. Application Data
(60) Provisional application No. 60/271,954, filed on Feb. 28, 2001.

(51) Int. Cl. B01F 11/00; B01F 13/08

(52) U.S. Cl. 366/116; 366/118; 366/127; 366/273

(57) ABSTRACT

An apparatus for mixing small volumes of liquids using a submerged permanent magnet impeller and a programmable electromagnet driver with variable frequency and magnetic field strength and field gradient. These variables and the duration of their application are controllable by a computer programmed with specific algorithms. The electromagnet driver has no moving mechanical parts. In a typical embodiment a small permanent magnet impeller is submerged in a solution to be mixed while contained in, say, a 1.5 mL Eppendorf conical tube or in a well of a multiwell plate. The tube or well to be mixed is placed above and in close proximity to the electromagnet driver. An operator inputs the frequency, field, gradient, and duration using a graphical user interface. The magnetic field applied to the impeller magnet via the driver electromagnet causes the impeller to undergo rapid motion in all planes thereby transferring momentum vertically in the solution.

### CROSS-REFERENCE TO RELATED APPLICATIONS

This application claims priority to U.S. Provisional Application No. 60/271,954, filed Feb. 28, 2001.

### STATEMENT REGARDING FEDERALLY SPONSORED RESEARCH OR DEVELOPMENT

The U.S. Government may have a royalty-free license to use, and to authorize others to use on its behalf, these data for Government purposes, and may be relieved of all disclosure prohibitions and assume no liability for unauthorized use of these data by third parties, as provided for by the terms of NAS8-39914 awarded by NASA.

### BACKGROUND OF THE INVENTION

This invention relates to an apparatus and method for mixing small volumes of liquid, which is especially applicable to large numbers of small samples of liquids in individual test tubes, multiwell plates, and reaction chambers. The invention alleviates the need for shaker platforms and single-sample vortexers in numerous laboratory procedures.

In general, vertical (or axial) momentum transfer is essential to thorough mixing. However, in conventional magnetically driven mixers, this vertical or axial momentum transfer typically requires the formation of a deep single vortex induced by body rotation of the stirred fluid volume. Such a vortex is very difficult to achieve by internal mixing in small volumes of liquid, below about 1.5 mL, as will be described below.

In the laboratory, standard bench scale liquid mixing devices include submerged shaft-driven impellers for volumes of about 0.5 to 100 liters (L); gyratory or oscillatory shaker tables for volumes of about 0.1 L to 10 L; and submerged magnetic impellers for volumes of about 10 to 5000 mL. However, when liquid volumes smaller than about 2 mL are to be mixed, it is customary to manually associate each sample with a vibrator that can produce a vigorous vortex in one or a few containers (tubes) at a time in order to achieve proper vertical (axial) momentum transfer for proper mixing. This is an extremely labor-intensive and operator-dependent method. When multiple volumes of such size are to be mixed, a gyratory or oscillatory shake table is used, as is the case for 0.1 to 10-L volumes as just mentioned.

However, this method is not preferred for mixing small samples of liquids as a result of two often-overlooked shortcomings. First, less that 1% of the power input to a multisample rack on a shake table is actually used for mixing. This means that the liquid sample represents only about 1% of the mass being shaken—an inefficient arrangement. Second, and more problematic, the inertial force imparted to the small liquid volume is often too small to overcome the surface tension force of the liquid in its container. This results in little or no momentum being transferred to the liquid. When inadequate momentum is transferred to a liquid, inadequate mixing is the result, and there is no precise standard of adequate mixing.

Many technologies and disciplines are in need of an apparatus and method that overcomes these deficiencies and achieves more efficient and more effective mixing of small volumes of liquids. Some examples of such technologies and disciplines, which are not meant to be limiting, include multisample thermocycling devices for polymerase chain reaction (PCR) amplification of gene sequences; combinatorial synthesizers using solid-phase or solution-phase polymerization of peptides or nucleic acids; 96-well format microtiter analytical plates for immunodiagnostic and calorimetric procedures; 24-well format analytical and culturing methods; mixing phases in two-phase extraction cavities having low volume; and in low-gravity applications in spacecraft where free liquid-gas interfaces cannot be formed. Practitioners of the arts of chemical and biochemical synthesis and analysis will appreciate additional applications of the immediate invention, and the above list is not intended as an exhaustive or exclusive list of potential applications of the immediate invention. These and many other applications could benefit by an apparatus which more efficiently and effectively imparts vertical or axial momentum transfer in small volumes of liquid.

### SUMMARY OF THE INVENTION

Accordingly, the present invention is directed to an apparatus and method for mixing small volumes of liquid. In particular, the present invention is directed to an apparatus and method that creates minute submerged free vortices that form as a result of turbulent motion of a solid impeller submerged in a small volume of liquid. These free vortices are distinguished from the forced deep single vortex, described above, that is readily created in larger volumes of liquids. The apparatus and method of the present invention create minute vortices that are critical to the homogeneous distribution of a dispersed phase within a liquid.

A major principle underlying the present invention is based on a temporally changing magnetic field generated by an electromagnet pulsed by an unrectified waveform of electrical current. Such a current waveform may be of any temporal shape but is preferably of alternating sign and in the frequency range 500 to 5000 Hz. When passed through the winding of the electromagnet, this current causes rapid alternating repulsive and attractive forces to be applied to a submerged permanent-magnet impeller. The submerged magnet impeller, under the influence of the rapidly reversing magnetic forces and the viscous forces of the surrounding fluid, undergoes a rapid vertically reciprocating, rotating, and tumbling motion that is nearly random in magnitude and direction and assuredly transfers momentum to the fluid in vertical planes and in radial and axial directions in a cylindrical container. The resulting turbulent flow produces microscopic eddies that lead to the uniform dispersal of solutes or particles in the liquid within which the permanent-magnet impeller moves.

The principle underlying this invention enables sufficient mixing to occur in the liquid sample in the absence of inertial forces or in the absence of a free liquid-gas interface. This means that the invention can be used in low-gravity and no-gravity situations (that is, in space) where no inertial forces are present. Furthermore, the invention can be used in completely sealed containers (in both terrestrial and extraterrestrial locations) where no liquid-gas interface exists.

A preferred embodiment of the immediate invention comprises one or a plurality of electromagnets—conductors wound in a cylindrical pattern or some other shape—positioned beneath a small liquid sample or plurality of samples to be mixed. These sample liquids contain a submerged permanent magnet impeller. The electromagnets serve as programmable impeller drivers with variable frequency and magnetic field strength and field gradient. The frequency, field strength, field gradient, and the duration of their application, are controllable by a computer programmed with algorithms for controlling said frequency, field strength, field gradient, and duration of their application. Ideally, the electromagnet driver has no moving mechanical parts.

In a typical embodiment and application a small permanent magnet impeller is submerged in a solution to be mixed while contained in, for example, a 1.5 mL Eppendorf conical tube. The tube is placed in a holder above and in close proximity to said electromagnet driver. An operator specifies the frequency, field, gradient, and duration using a graphical user interface. In one embodiment the interface allows entry by the operator of properties of the solution to be mixed, and the algorithm computes and executes the necessary frequency, field, gradient, and duration. When a magnetic field is applied to the impeller by the electromagnet driver, the impeller undergoes rapid motion in all planes thereby transferring considerable momentum vertically (axially) in the solution to be mixed.

A significant feature of the immediate invention is the ability to program the electromagnetic drivers. The operator has three options: (1) enter the viscosity and density of the solution and the diffusivity of the solute; (2) enter the name of the solution from a menu; or (3) enter the desired electromagnet current, frequency and duration of mixing. Options (1) and (2) are based on algorithms derived from the theory of homogeneous isotropic turbulence, from which required power levels and mixing times can be calculated on the basis of solution and solute properties. Option (3) is possible in situations wherein the operator desires to mix based upon manual parameters.

### BRIEF DESCRIPTION OF THE DRAWINGS

The teachings of the present invention can be readily understood by considering the following detailed description in conjunction with the accompanying drawings, in which:

FIG. 1a is a perspective view of a conventional magnetic mixer for large samples of liquids, with arrows indicating the momentum transferred thereby;

FIG. 1b is a perspective view of an embodiment of the present invention for small volumes of liquid, with arrows indicating the momentum transferred in a sample by the submerged magnetic impeller driven by an electromagnetic mixer driver;

FIG. 2 is a block diagram of the mixing apparatus according to one embodiment of the present invention;

FIG. 3 is a flow chart of a computer algorithm for controlling an embodiment of the mixing system;

FIG. 4a is a perspective view of an embodiment of the present invention in which a circular array of samples is mixed and in which the impeller magnets are attached to a horizontal axle on which they rotate to transfer momentum vertically;

FIG. 4b is a detail of an impeller magnet shown in FIG. 4a;

FIG. 5 is a series diagram of a typical countercurrent extraction procedure conducted on a sample of liquid using the current invention, showing a single cycle of steps in countercurrent extraction; and

FIG. 6a is a partial perspective view of a typical thermocycling block or synthesizer device utilizing an embodiment of the present invention to mix a sample in a rectangular array by submerging a magnetic impeller into each sample and placing each sample over one of a plurality of computer-controlled electromagnets; and

FIG. 6b is a partial perspective view of a typical multiwell (96-well or 24-well microtiter plate) device utilizing an embodiment of the present invention to mix a sample by submerging a magnetic impeller into each sample and placing each sample over one of a plurality of computer-controlled electromagnets.

### DETAILED DESCRIPTION OF THE PREFERRED EMBODIMENT

While the present invention will be described more fully hereinafter with reference to the accompanying drawings, in which particular embodiments and methods are shown, it is to be understood from the outset that persons of ordinary skill in the art may modify the invention herein described while achieving the functions and results of this invention. Accordingly, the descriptions which follow are to be understood as illustrative and exemplary of specific embodiments within the broad scope of the present invention and not as limiting the scope of the invention. In the following descriptions, like numbers refer to similar features or like elements throughout.

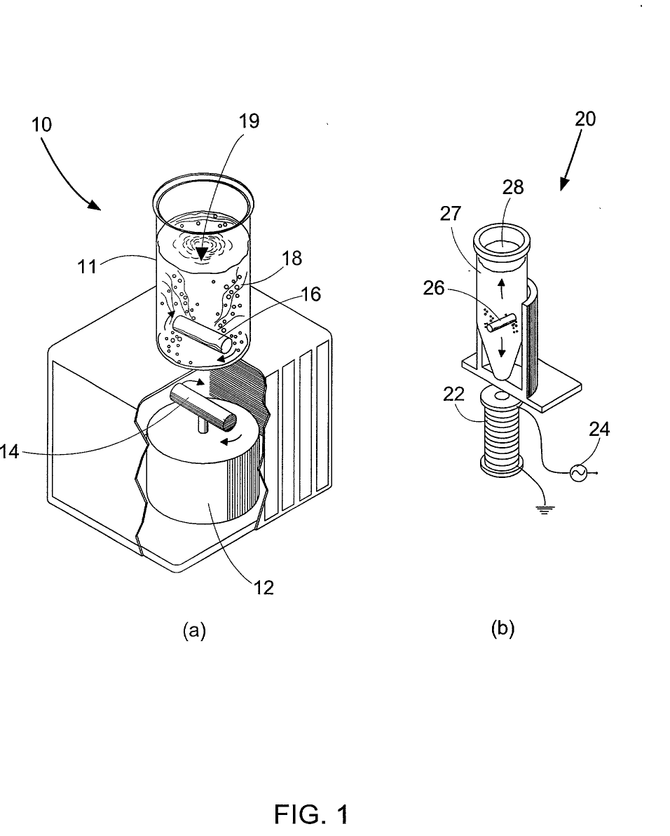

FIGS. 1a and 1b illustrate a conventional magnetic impeller mixing apparatus 10 and an apparatus 20 according to one embodiment of the present invention, respectively. In a conventional magnetic-impeller mixing apparatus 10, a rotating motor 12 rotates a permanent magnet 14, the field of which couples with that of a permanent magnet impeller 16 submerged in a solution 18 to be mixed. A vortex 19 is commonly formed in solution 18 which transfers momentum vertically or axially within solution 18 to effect mixing in all dimensions. This vertical or axial transfer of momentum is critical to the mixing process and is, in conventional mixing, dependent on macroscopic vortex formation, that is, formation of vortex 19. The volume of solution 18 represented in beaker 11 in the diagram is typically 50 mL.

FIG. 1b illustrates a preferred single station embodiment of the present invention. The apparatus 20 comprises electromagnet driver 22 which is powered by a signal generator 24, the frequency and current of which can be controlled by an operator 100 (not shown), typically via computer programs. The signal generated by signal generator 24 is typically a sinusoidal wave, but can be generally any wave type suitable for the purpose of powering electromagnet drivers, including, but not limited to, saw-tooth wave forms and square wave forms. Those skilled in the art will understand that an infinite number of possible wave forms may be generated by computer or electronically for use in the present invention. Electromagnet driver 22 creates a rapidly rising and falling electromagnetic field that couples to that of a permanent magnet impeller 26 located within a small volume of liquid, or liquid sample 28, that is contained in a liquid sample container 27. Liquid sample container 27 can take many forms, including but not limited to, test tubes, Eppendorf tubes, beakers, graduated cylinders, wells in standard multi-well plates, and any other vessel suitable for housing liquids. This changing electromagnetic field, along with viscous forces in the liquid sample 28, causes translation of impeller 26 in multiple directions in all planes. This motion, spurred by modulated magnetic field produced by electromagnet driver 22, mixes the liquid sample 28, using the submerged permanent magnet impeller 26. It is this motion of permanent magnet impeller 26, in contrast to the conventional mixers, that provides the desired vertical (axial) momentum transfer. Electromagnet driver 22 advantageously has no moving parts. The liquid sample 28 represented in the tube in the diagram is typically 1 mL.

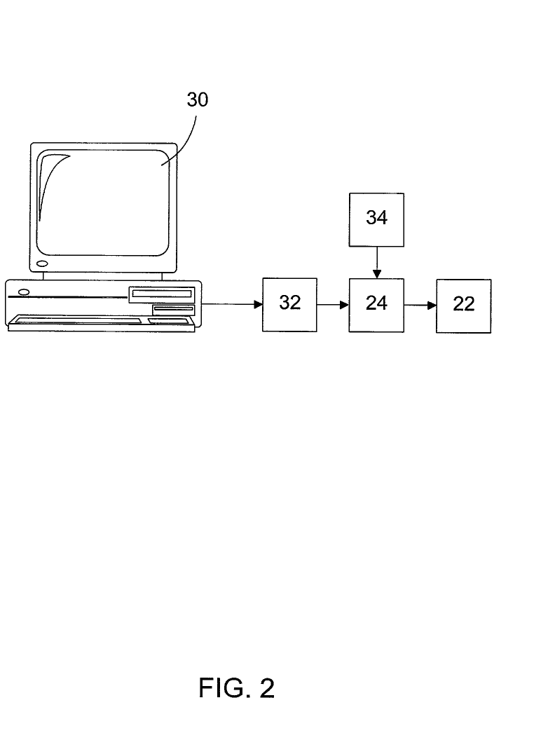

FIG. 2 illustrates a typical arrangement for the major components of the present invention. One or a plurality of electromagnet drivers 22 receive(s) a power signal of programmed frequency and current from signal generator 24. Signal generator 24 receives electrical power from DC power supply 34 and commands from electronic controller 32. The electronic controller 32 produces a conditioned electronic signal established by the output of computer 30 controlled by a graphical user interface (GUI) or similar laboratory interface software.

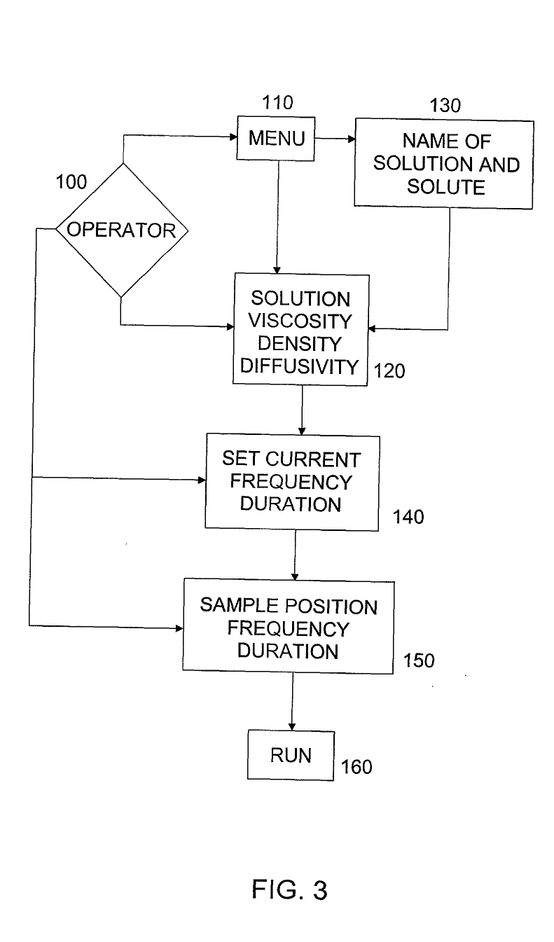

FIG. 3 illustrates a flow diagram for an operating program usable in conjunction with a computer to operate the present invention. A significant feature of the immediate invention is the ability to program the electromagnetic drivers 22. The operator 100 has at least three options. First, operator 100 may use menu 110 to enter at 120 the viscosity and density of the solution and the diffusivity of the solute. Second, operator 100 may enter at 130 the identity of a liquid or solution by selecting from a menu. Third, operator 100 may enter at 140 the desired electromagnet current, frequency, and duration of mixing. The first and second options incorporate algorithms derived from the theory of homogeneous isotropic turbulence, from which required power levels and mixing times can be calculated on the basis of solution and solute properties. The algorithms are used to calculate these outputs and signal the electronic controller 32 accordingly. At 150, the operator 100 has an opportunity to enter parameters for different samples if operator 100 chooses to vary the parameters among samples. After operator 100 has made an entry or chosen not to make an entry at 150, the operator 100 proceeds to activation step 160, and appropriate signals are passed from the computer 30 to the controller 32.

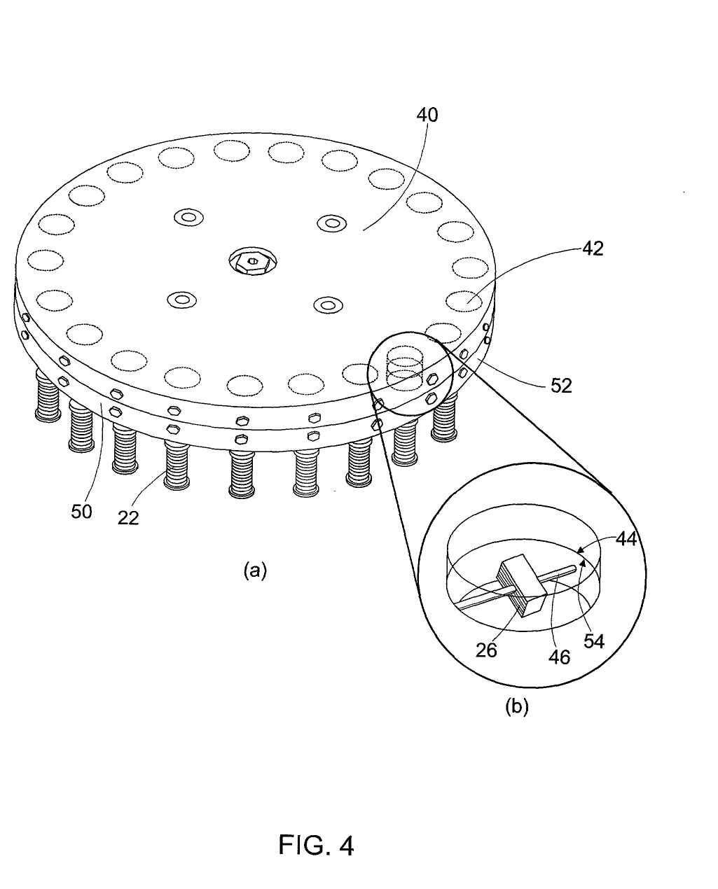

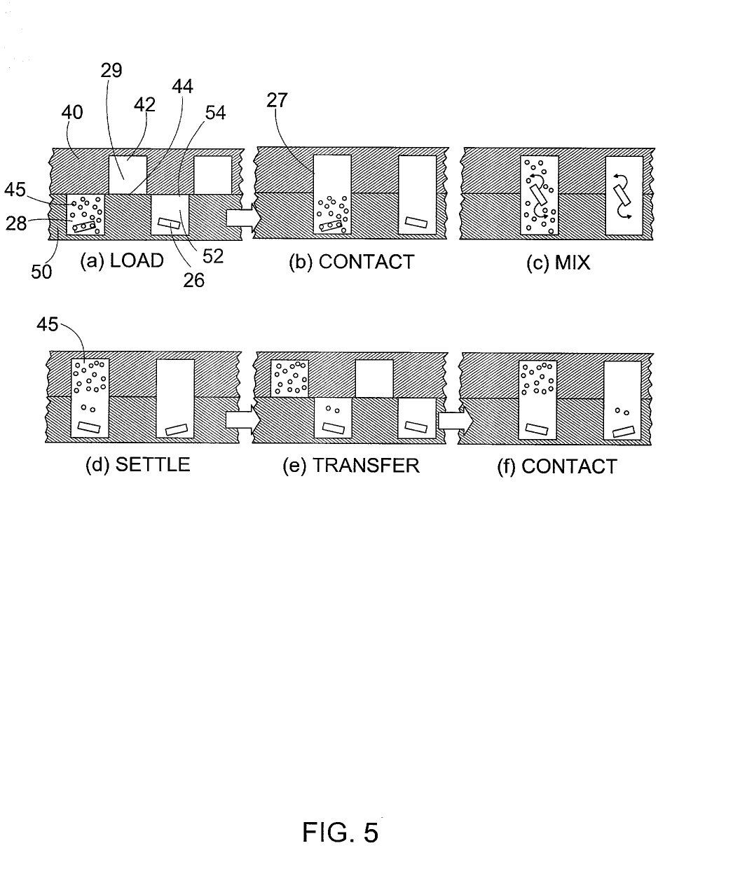

FIG. 4a illustrates an embodiment of the invention wherein an upper plate 40 has a first ring of cavities 42 defined around the circumference of the upper plate 40 at a distance from the center of the upper plate 40; and a lower plate 50 has a second ring of cavities 52 similarly defined therein. First ring of cavities 42 have openings 44 facing openings 54 in second ring of cavities 52, as best shown in FIG. 5. First and second rings of cavities 42 serve the function of a plurality of small volumes of liquid 28. Each of the individual cavities 52 houses a permanent magnet impeller 26 which, in this embodiment, is held in place by an axle 46 about which the magnet impeller 26 is free to rotate. The upper plate 40 and lower plate 50 are positioned in proximity to electromagnet drivers 22 which activate each magnetic impeller 26. After mixing (and demixing in the case of immiscible liquids) lower plate 50 rotates about a common axis with respect to upper plate 40 (or vice versa), thereby separating the upper half of each of the plurality of cavities 42 from its corresponding lower half 52, and subsequently contacting the upper half of cavities 42 with the next lower half of cavities 52 in the ring. The magnetic mixing process and intervening fluid transfers can be repeated up to 22 times in the embodiment shown, which is also known as “BISEP” biphasic multistage extractor. However, it will be understood that any number of repetitions may be employed, depending on the size of the plates 40; the number of cavities 42 therein; and the number of steps needed to achieve mixing, demixing, purification, and so forth. The sample size of liquid sample 28 in this embodiment is less than 1.0 mL, and the number of electromagnet drivers 22 is twenty-two.

FIG. 4b shows a detail of one of magnetic impeller 26 rotatable about axle 46. In this embodiment, rather than random motion of the impeller 26, simple rotation about axle 46 is employed.

Referring again to FIGS. 4 and 5, a method of countercurrent extraction utilizing the present invention is shown. In countercurrent extraction, separands 45 (species of dissolved molecules or suspended particles) are transferred between phases for the purpose of their purification. FIG. 5a illustrates lower immiscible liquid sample 28 initially contains separands 45 to be separated by extraction into upper phase liquid sample 29. Lower immiscible phase liquid sample 28 is initially contained in a plurality of cavities 52 in lower plate 50, and one of these cavities contains a starting mixture of separands 45. Upper immiscible phase liquid sample 29 is initially contained in a plurality of inverted cavities 42 in upper plate 40. FIG. 5b illustrates the contacting of the two immiscible phases by the sliding (rotation) of lower plate 50 and the formation of an interface between the two immiscible phases of liquid samples 29. These phases 29 are next mixed vigorously using an embodiment of the present invention, as best shown in FIG. 5c. As can be seen, the apparatus 20 allows the transfer of mass between the two immiscible liquid samples 29. Mixing is terminated and particles distribute themselves between the phases on the basis of thermodynamic equilibrium, as indicated in FIG. 5d. This process is repeated until all top phases 29 have been combined with bottom phases 28 to the right, and all bottom phases 28 have been contacted with top phases to the left 29, hence the name “countercurrent distribution” of separands. The present invention replaces the conventional mixing method in which mass transfer was achieved by shaking the entire assembly illustrated in FIG. 4.

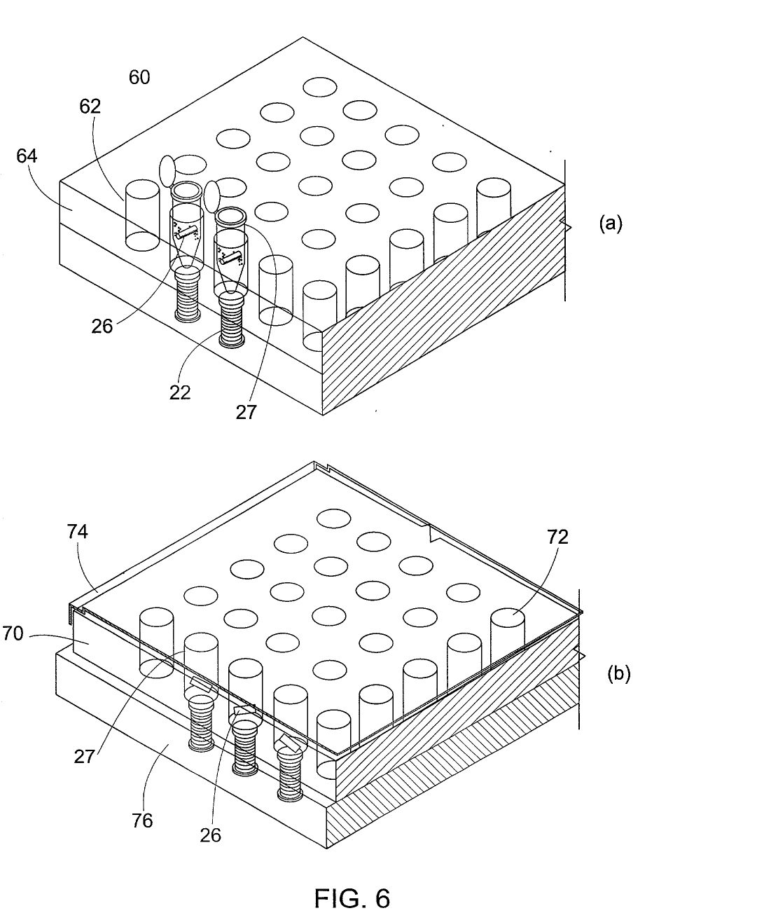

Additional embodiments are depicted in FIG. 6. FIG. 6a is a multiple station embodiment of the single station embodiment of FIG. 1b. FIG. 6b shows a portion of a typical 96-well plate system (12×8), which is the most common embodiment of such plates used in the art. Persons of ordinary skill in the art will recognize that any number of wells are possible with this invention, and other common sizes are 24-well and 72-well plates.

Referring now to FIG. 6a, the liquid sample containers 29 are Eppendorf tubes 60 having a capacity of approximately 1.5 mL are shown captured in the wells 62 of a reaction block 64. Said reaction blocks 64 are typically used to polymerize specific sequences of nucleic acids or peptides by a variety of synthetic methods involving enzymes and/or artificial substrates, and/or catalysts and/or immobilizing agents. Well-known applications of such reaction blocks 64 include, but are not limited to, enzymatic amplification of limited quantities of a gene sequence (also known as polymerase chain reaction—PCR), randomized amplification of nucleic acid or peptide sequences in combinatorial chemistry, and semi-solid synthesis of nucleic acids and peptides. A permanent magnet impeller 26 is submerged in the liquid sample 28 in each Eppendorf tube 60, and the plurality of Eppendorf tubes 60 in their wells 62 in rectangular array is placed atop a corresponding rectangular array of electromagnet drivers 22.

FIG. 6b illustrates an alternative embodiment wherein the liquid sample containers 29 comprise a rectangular array of a plurality of fixed wells 72 in rectangular array in a single plate 70. The plate 70 may typically contain 96 or 24 wells, and typically has a single cover 74 for the entire array of wells 72. Beneath each of the wells 72, on its own platform, is a corresponding rectangular array 76 of a plurality of electromagnetic drivers 22, one beneath each well 72. Electromagnetic drivers 22 couple with the permanent magnet impellers 26 (also known, in this case, as “fleas”) in each corresponding well 72. A typical volume per well 72 is 0.25 mL.

Various embodiments of the present invention have been tested, and one of these will be described in the following example.

### EXAMPLE

FIG. 4, as explained above, illustrates an embodiment of the present invention that works extremely well for its intended purpose. In particular, a criterion for complete mixing was established in the serial transfer mode provided by the embodiment shown in FIG. 4. The details of a single transfer cycle using the embodiment of FIG. 4 are shown in FIG. 5. All twenty-two upper liquid sample containers, cavities 42, were filled with pure water, and twenty-one of the lower liquid sample containers, cavities 52, were filled with pure water. One lower liquid sample container cavity 52, called the first liquid sample container, was filled with a solution consisting of 0.4% trypan blue dye (or any clearly visible dye) and 99.6% pure water. Referring to FIG. 5, upper and lower liquid containers were brought into contact and mixed for ten seconds by magnet impeller 26 driven at 500 cycles per minute, and the upper and lower volumes of liquid were again separated from one another. This process was repeated twenty-two times using plates 40 and 50 each having twenty-two liquid sample containers. A mathematical relationship predicts that, after twenty-two transfers of the type shown in FIG. 5, the highest concentration of dye should appear in the 11^{th} upper liquid sample container from said first liquid sample container, and the amount of dye in all other containers is also predicted. When mixing was complete, the dye concentration was distributed in this predicted fashion. After twenty-two countercurrent transfers in the device of FIG. 4, solute concentration was measured in all twenty-two cavities and found to be as predicted on the basis of complete mixing. Thus twenty-two tests of the immediate invention were performed in a single experiment, which was repeated several times with identical results. Furthermore, this test was performed in the absence of gravity during a space shuttle flight, and it was further demonstrated that complete mixing by the invention is independent of the gravity vector. That is, the invention should function in any orientation that allows the magnetic field of the electromagnet driver to couple with that of the permanent magnet impeller. This means that the invention works even in the absence of inertial forces, in closed or open containers.

Successful mixing is achieved by the embodiments of the present invention as a result of, and dependent upon, assumptions of the homogeneous isotropic turbulence model. In this model an impeller must generate turbulent flow, which is assumed to produce eddies. Each eddy is assumed to consist of a small unstirred stagnant volume having a specified diameter and being surrounded by a fully-mixed dispersion. Mixing is assumed to be complete when the dispersed phase has had time to diffuse across an eddy.

Turbulence is judged by the magnitude of Reynolds number (Re) using the relationship

Re=ρlv/η

where ρ=density of fluid;

l=length of impeller;

v=velocity of rotation; and

η=viscosity of the fluid.

If Re>2,000 turbulence is commonly assumed. In a typical embodiment of the present invention, Re=3,000; therefore, turbulence is assumed.

In the theory of homogeneous isotropic turbulence the diameter of stagnant zones is calculated from the impeller power density (Power/Volume) and the viscosity and mass density of the dispersion. This diameter is also known as Kolmogoroff length, thus:

Kolmogoroff length=f(viscosity, density, P/V).

Furthermore, the time required for complete mixing is calculated as the time required for a dissolved molecule or suspended particle to diffuse a distance equal to the Kolmogoroff length by Brownian diffusion using the Einstein diffusion equation:

Mixing time=[Kolmogoroff length]²/4[diffusion coefficient]

In a typical embodiment of the immediate invention, mixing time for a dissolved solute in water is of the order of 10 s.

Some additional background and sample calculations are useful. In a fully enclosed cylinder with no vapor space, such as is required in orbital spacecraft and often in the mixing of hazardous liquids, a stir bar rotating at about 500 rpm at the bottom of the vessel will typically input a power density of 1,000 W/m³. At the top of the closed vessel, owing to the no-slip boundary condition, this is zero. Assuming Couette Flow, the rotational velocity should reduce linearly from 500 rpm at the bottom to zero rpm at the top. Power density goes as the square of rotational velocity [(rpm)²]. This means, for example, that ¾ of the way up the vessel, power density is 1/16 that at the bottom, and the required mixing time, according to the theory of homogeneous isotropic turbulence, is about 60 times as long at this position as at the bottom of the vessel. Typical mixing times at this velocity would be about 10 s at the bottom and 10 min at the top. For some reactions this would be too much heterogeneity, and for some processes this would be too much time. The transfer of momentum randomly, including vertically at 500 rpm, on the other hand, eliminates the heterogeneous distribution of mixing times.

A vortex, in the classical sense, cannot form in a fully enclosed liquid with no vapor phase, except in exceptional cases in which the fluid is compressed causing cavitation. In most practical terms, performing experiments in low gravity requires that the entire contents of a container be liquid and no vapor phase is present. This requirement presents the mixing problem discussed above, and also eliminates the possibility of forming a classical vortex.

Expanding upon the homogeneous isotropic turbulence model discussed previously indicates the effects on mixing created by a random impeller. Any object moving through a fluid at high Reynolds number (that is, Re>2,000) causes fluid motion in its vicinity by destabilizing its own laminar streamline and shedding vortices, also known as eddies. If turbulent flow is indicated on the basis of Reynolds number, then, to a good approximation the theory of homogeneous isotropic turbulence can be applied to the evaluation of mixing. In this theory, the Kolmogoroff length, as discussed above (which is a characteristic length), is calculated on the basis of the power density of the impeller (Watts/m³) and the density and viscosity of the fluid. This length is taken as the diameter of a characteristic unmixed zone over which complete homogenization of a solute or suspension of particles requires diffusion. So, in a sample calculation, an impeller may impart 1,000 Watts/m³ to a tank, and the resulting Kolmogoroff length is 10⁻⁵ cm, then a solute with a diffusion coefficient of 10⁻⁶ cm²/s will require 10⁻⁵ cm/10⁶ cm²/s=10 s to be fully mixed. Thus the idea of turbulent mixing is to reduce the distance, and hence the time, required for solutes or suspended particles to become homogeneously dispersed by diffusion.

On the basis of the above typical numbers, the need for vigorous mixing of particle suspensions is made clear. Some particles have diffusion coefficients as low as 10⁻⁹ cm²/s or even less. This means, in the example just explained, the complete mixing time would be 10⁴ s or 3 hours. However, simply doubling the rpm reduces the time required to several minutes. The present invention is capable of numerous mixing rates between about 50 and about 2000 rpm.

The algorithms involved in the embodiment, as stated above, can allow operators at least three options to perform proper mixing. One option involves having an empirical formula provided in the computer algorithm so the operator need enter only the viscosity and molecular weight (or density of solution or diffusivity of solute) of the species to be fully mixed. A second option allows the operator simply to select from a menu list of most-frequently-used solutions' names, which include, but are not limited to, the following:

tissue culture medium with 10% serum;

buffer solution with 50% phenol extractant;

phosphate buffered saline;

physiological saline;

human blood, undiluted;

human blood diluted 50%;

20% solution of PEG 8,000;

1% protein solution in neutral buffer;

10% protein solution in neutral buffer;

50% protein solution in neutral buffer;

1% nucleic acid solution in aqueous buffer;

peptide synthesis reagent;

1% nucleic acid solution in ethanol;

suspension of 10⁹ bacteria/mL broth;

suspension of 10⁶ animal cells/mL broth.

And, as stated above, a third option allows the operator simply to input the desired electromagnet current, frequency, and duration of mixing. Subsequently the device is then activated to commence the mixing operation.

While there has been described and illustrated particular embodiments of a novel device and method for efficiently mixing small volumes of liquid, it will be apparent to those skilled in the art that variations and modifications are possible without deviating from the broad spirit and principle of the present invention, which shall be limited solely by the scope of the claims appended hereto.

What is claimed is:

1. An apparatus for mixing liquids comprising:
(a) a liquid sample within a liquid sample container;
(b) a magnetic impeller located in said liquid sample container; and
(c) an electromagnetic driver located in proximity to said magnetic impeller wherein said electromagnetic driver is powered by a signal generator.

2. The apparatus of claim 1, wherein said magnetic impeller has a magnetic field coupled to an electromagnetic field of said electromagnetic driver.

3. The apparatus of claim 2, wherein said signal generator produces a signal of programmed frequency and current.

4. The apparatus of claim 3, wherein said signal of programmed frequency and current causes said electromagnetic field of said electromagnetic driver to vary with time.

5. The apparatus of claim 4, wherein said electromagnetic driver imparts motion to said magnetic impeller in said liquid sample container as a result of a coupled electromagnetic field.

6. The apparatus of claim 5, wherein said motion of said magnetic impeller transfers momentum through said liquid sample.

7. The apparatus of claim 6, wherein said motion of said magnetic impeller is random.

8. The apparatus of claim 6, wherein said magnetic impeller is mounted on an axle located within said liquid sample container.

9. The apparatus of claim 8, wherein said motion of said magnetic impeller is rotational about said axle.

10. The apparatus of claim 6, wherein said electromagnetic driver has no moving parts.

11. The apparatus of claim 3, wherein said signal of programmed frequency and current is controlled by a computer implemented algorithm.

12. The apparatus of claim 3, wherein said frequency and current of said programmed signal is controlled by an operator.

13. The apparatus of claim 11, wherein said signal generator produces a wave form selected from the group consisting of sinusoidal waves, square waves, and sawtooth waves.

14. The apparatus of claim 12, wherein said signal generator produces a wave form selected from the group consisting of sinusoidal waves, square waves, and sawtooth waves.

15. The apparatus of claim 3, wherein said liquid sample container comprises an Eppendorf tube.

16. The apparatus of claim 3, wherein said liquid sample container comprises a plurality of vessels arranged in a geometric array.

17. The apparatus of claim 16, wherein said geometric array comprises 24 vessels.

18. The apparatus of claim 16, wherein said geometric array comprises 96 vessels.

19. The liquid sample of claim 16, wherein said geometric array is a circular array.

20. The apparatus of claim 3, wherein said liquid sample container comprises a container suitable for low gravity applications.

21. A method for mixing liquids comprising the steps of:
a) providing a liquid sample in a liquid sample container;
b) providing a magnet impeller within said liquid sample;
c) providing an electromagnetic driver in proximity to said magnetic impeller;
d) providing a signal generator electrically connected to said electromagnetic driver; and
e) altering the signal generated by said signal generator, wherein said electromagnetic driver creates a rapidly rising and falling electromagnetic field that couples to a magnetic field of said magnetic impeller, wherein said rapidly rising and falling electromagnetic field causes said magnetic impeller to move.

22. The method of claim 21, wherein said signal generator produces a signal of programmed frequency and current.

23. The method of claim 22, wherein said signal of programmed frequency and current causes said electromagnetic field of said electromagnetic driver to vary with time.

24. The method of claim 23, wherein said electromagnetic driver imparts motion to said magnetic impeller in said liquid sample as a result of a coupled electromagnetic field.

25. The method of claim 24, wherein said motion of said magnetic impeller transfers momentum through said liquid sample.

26. The method of claim 25, wherein said electromagnetic driver has no moving parts.

27. The method of claim 21, wherein said signal of programmed frequency and current is controlled by a computer implemented algorithm.

28. The method of claim 21, wherein said frequency and current of said programmed signal is controlled by an operator.

29. The method of claim 27, wherein said signal generator produces a wave form selected from the group consisting of sinusoidal waves, square waves, and sawtooth waves.

30. The method of claim 28, wherein said signal generator produces a wave form selected from the group consisting of sinusoidal waves, square waves, and sawtooth waves.

31. The method of claim 21, wherein said liquid sample container comprises an Eppendorf tube.

32. The method of claim 21, wherein said liquid sample container comprises a plurality of vessels arranged in a geometric array.

33. The method of claim 32, wherein said geometric array comprises 24 vessels.

34. The method of claim 33, wherein said geometric array comprises 96 vessels.

35. The method of claim 34, wherein said geometric array is a circular array.

36. The method of claim 35, wherein said liquid sample container comprises a container suitable for low gravity applications.

37. A system for mixing liquids comprising:
a) a liquid sample within a liquid sample container;
b) a magnetic impeller located within said liquid sample container;
c) a programmable electromagnetic driver located in proximity to said magnetic impeller and electrically coupled to a signal generator that receives electrical power from a power supply and commands from an electronic controller wherein said electronic controller produces a conditioned electronic signal established by an output of a computer.

38. The system of claim 37, wherein said conditioned electronic signal is produced by means of one or more algorithms programmed into said computer.

39. The system of claim 38, wherein said algorithm receives input in the form of viscosity and density of said liquid sample and diffusivity of a solute.

40. The system of claim 38, wherein said algorithm receives input in the form of a liquid identifier of a liquid sample selected from a menu.

41. The system of claim 38, wherein said algorithm receives input in the form of electromagnetic current, frequency, and duration of mixing.

42. A method for biphasic extraction comprising the steps of:
a) providing a liquid sample in a liquid sample container;
b) providing a magnet impeller within said liquid sample container;
c) providing an electromagnetic driver in proximity to said magnetic impeller;
d) providing a signal generator electrically connected to said electromagnetic driver; and
e) altering the signal generated by said signal generator, wherein said electromagnetic driver creates a rapidly rising and falling electromagnetic field that couples to an electromagnetic field of said magnetic impeller, wherein said rapidly rising and falling electromagnetic field causes said magnetic impeller to move in random directions.

43. A method for mixing liquids in the absence of free liquid to gas interfaces or in the absence of inertial forces comprising the steps of:
a) providing a liquid sample in a liquid sample container;
b) providing a magnet impeller within said liquid sample container;
c) providing an electromagnetic driver in proximity to said magnetic impeller;
d) providing a signal generator electrically connected to said electromagnetic driver; and
e) altering the signal generated by said signal generator, wherein said electromagnetic driver creates a rapidly rising and falling electromagnetic field that couples to an electromagnetic field of said magnetic impeller, wherein said rapidly rising and falling electromagnetic field causes said magnetic impeller to move in random directions.

44. An apparatus for mixing liquids comprising:
a) a volume of liquid within a liquid sample, wherein said liquid sample is contained in a liquid sample container comprising a plurality of vessels arranged in a geometric array;
b) a permanent magnetic impeller located in said liquid sample container;
c) an electromagnetic driver having an electromagnetic field associated therewith, said electromagnetic driver located in proximity to said permanent magnetic impeller wherein said electromagnetic driver comprises no moving mechanical parts; and
d) a signal generator electrically coupled to said electromagnetic driver wherein said signal generator produces a signal of programmed frequency and current which causes said electromagnetic field of said electromagnetic driver to vary with time, thus imparting motion to said permanent magnetic impeller in said liquid sample as a result of a coupled electromagnetic field between said permanent magnetic impeller and said electromagnetic driver, and wherein said frequency and current of said programmed signal is controlled by an operator.
